(19) United States
(12) Patent Application Publication
(10) Pub. No.: US 2007/0078803 A1
(43) Pub. Date: Apr. 5, 2007

(54) Method, system and apparatus for searchcasting with privacy control

(76) Inventors: David L. Gilmour, Los Altos Hills, CA (US); Jonathan M. Goldberg, San Francisco, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/244,715

(22) Filed: Oct. 5, 2005

(51) Int. Cl. G06F 17/30

(52) U.S. Cl. 707/1

(57) ABSTRACT

A user initiated query is requested, from a searchcasting server, by a plurality of target computers. At least one of the target computers is selected to prompt its user to indicate permission or denial of permission to send a response to the query if the target computer determines that a match of the query satisfies a predetermined match level.

### FIELD OF THE INVENTION

At least one embodiment of the present invention pertains to computer-implemented information search and sharing technology, and more particularly, to searchcasting, the integration of desktop search technology with enterprise or Web search technology.

### BACKGROUND

With the development of computer technology, especially network technology, information search has become a hot area of scientific research as well as industrial competition. Today, Web search and enterprise search have become the most popular ways through which people find information.

For example, a Web search may be conducted through a Web based search engine or portal (i.e., google.com, msn.com, etc.). A Web based search server provides a search portal through which a user may submit his search request (query) from his computer via a network (i.e., LAN, WAN, the Internet, etc.). In most cases, a Web based search server maintains and periodically updates its index of all information published by all computers on the Internet so that when a search request is received, the result will be quickly available. Thus, much of the information published on the Internet is made searchable and accessible through these various search portals.

Information stored on a computer may be classified into three categories: published information (e.g., Web pages that are assessable by the public via the Internet), limited access information (e.g., information stored in an organization's database), and private information (e.g., email, personal data, confidential information, etc.). For a Web search, such as a Google Web search, only published information, however, is searchable and accessible. Limited access information and private information, however, can not be reached by such a Web search.

To access limited access information, such as information in a corporate database, a search server is usually configured in a way such that a user is authenticated before his search may be processed. Similar to a Web search, the search server provides a portal through which an authenticated user (e.g., authenticated by a login process) submits a search request from his computer. The search server then distributes the search request to a database server, so that limited access information may be pulled out from a database by a search engine. The search server may also distribute the search request to a plurality of database servers. In that case, a so called “federated search” is conducted. A “federated search” may be defined as simultaneous search and retrieval from different databases and electronic resources.

Microsoft, Yahoo, Google, and others have recently introduced “desktop search” software that can be downloaded by users on their personal computers (PCs) to allow them to index and rapidly locate information of any kind on their PCs. For example, a desktop search engine can index and search all categories of information, including published information, limited access information, and private information. Through the enormous popularity of desktop search technology, the entire base of information on PCs throughout the world is rapidly becoming indexed and separately searchable to the users of those PCs, but not to anyone else. The reason is obvious: users consider their PCs to be personal and are unwilling to simply allow access to their hard disks for searching by others.

In a business enterprise, this creates a significant missed opportunity. If the background indexing of user PCs could be harnessed for the purposes of the overall organization, for example, information technology (IT) managers would embrace and support desktop search technology, and the enterprise could benefit in the form of dramatically expanded sharing of information and better collaboration, because, for the first time, all content on any user's PC in the enterprise potentially would be available for sharing. Enterprises could also simplify their IT strategies and reduce expenses by eliminating many technologies and processes designed to “manage” content. In place of these strategies, content could simply be left where it is and accessed on user PCs.

Thus, a system is needed to accomplish the enterprise or Web integration of desktop search and to solve the privacy issues as well.

### SUMMARY OF THE INVENTION

The present invention includes a method and processing system for searchcasting. The method comprises sending a user initiated query for information to a plurality of computers distributed on a network, receiving a first message in response to the query from at least one of the computers, and in response to the first message or messages, sending a second message to at least one of the computers to cause the computer to prompt a user of the computer to indicate permission or denial of permission to send a response to the query.

Another aspect of the present invention includes receiving, at a first computer, from a server, a user initiated query for information, which is also being received from the server by at least a second computer, and upon detecting a match of the query at the first computer, prompting a user of the computer to indicate permission or denial of permission to send a response to the query.

Other aspects of the invention will be apparent from the accompanying figures and from the detailed description which follows.

### BRIEF DESCRIPTION OF THE DRAWINGS

One or more embodiments of the present invention are illustrated by way of example and not limitation in the figures of the accompanying drawings, in which like references indicate similar elements and in which:

FIG. 1 is a high-level block diagram of a computer system;

FIG. 2 illustrates an architecture of a searchcasting system with client side step-down auction;

FIG. 3 is a block diagram of a computer system with a desktop search engine and a Client Side Auction Control Logic (CSACL) installed on it;

FIG. 4 illustrates the data structure of a query object;

FIG. 5 illustrates the data structure of an anonymous response;

FIG. 6 is a flow diagram showing a process of searchcasting with client side step-down auction on a target computer;

FIG. 7 is a flow diagram showing a process of calculating a strength of knowledge base of a user of a target computer with respect to the subject matter of a query;

FIG. 8 is a flow diagram showing a process of searchcasting with client side step-down auction on a searchcasting server;

FIG. 9 is a flow diagram showing a process of searchcasting with robust user privacy protection on a target computer;

FIG. 10 illustrates an architecture of a searchcasting system with server side auction;

FIG. 11 illustrates the data structure of a query object;

FIG. 12 illustrates the data structure of a bid;

FIG. 13 is a flow diagram showing a process of searchcasting with server side auction on a target computer;

FIG. 14 is a flow diagram showing a process of searchcasting with server side auction on a searchcasting server;

FIG. 15 illustrates an architecture of a searchcasting system with server side target filtering;

FIG. 16 is a flow diagram showing a process of searchcasting with server side target filtering on a searchcasting server;

FIG. 17 is a flow diagram showing a process of searchcasting with server side target filtering on a target computer; and

FIG. 18 is a flow diagram showing an algorithm of calculating the strength of a content match.

### DETAILED DESCRIPTION

A method, system and apparatus for searchcasting are described. References in this specification to “an embodiment”, “one embodiment”, or the like, mean that the particular feature, structure or characteristic being described is included in at least one embodiment of the present invention. Occurrences of such phrases in this specification do not necessarily all refer to the same embodiment.

The technique introduced here integrates desktop search with enterprise or Web search by combining federated search with a privacy control mechanism. First, a user initiated query for information is distributed, from a server, to a plurality of target computers via a network. The query is then processed individually on each computer. At least one computer is chosen for matched information stored on it, i.e., the selection may be based on relevancy of the matched information, relationship between the querying user and the user who controls the matched information, the user's knowledge base with respect to the subject matter of the query, and/or other criteria. Each of the selected computer(s) then alerts the user of the match and prompts the user to indicate whether he is willing to respond to the query, i.e., authorize the release of the matched information to the querying user, contact the querying user for further communication with respect to the query, etc. Before the user chooses to respond to the query (i.e., authorizing the release of the matched information sought), all communications, if any, from the computer to the server are anonymous such that they cannot be used to identify the identity of the user. No private information leaves the computer until the user of that computer (i.e., the “owner” of that information) allows it. Thus, the privacy issue is also addressed in this searchcasting system. Note that the term “match” in this specification means either a process of measuring the correspondence between two things or a result that the degree of the correspondence between two things satisfies a condition. Which meaning of the term applies will be self evident within the particular context.

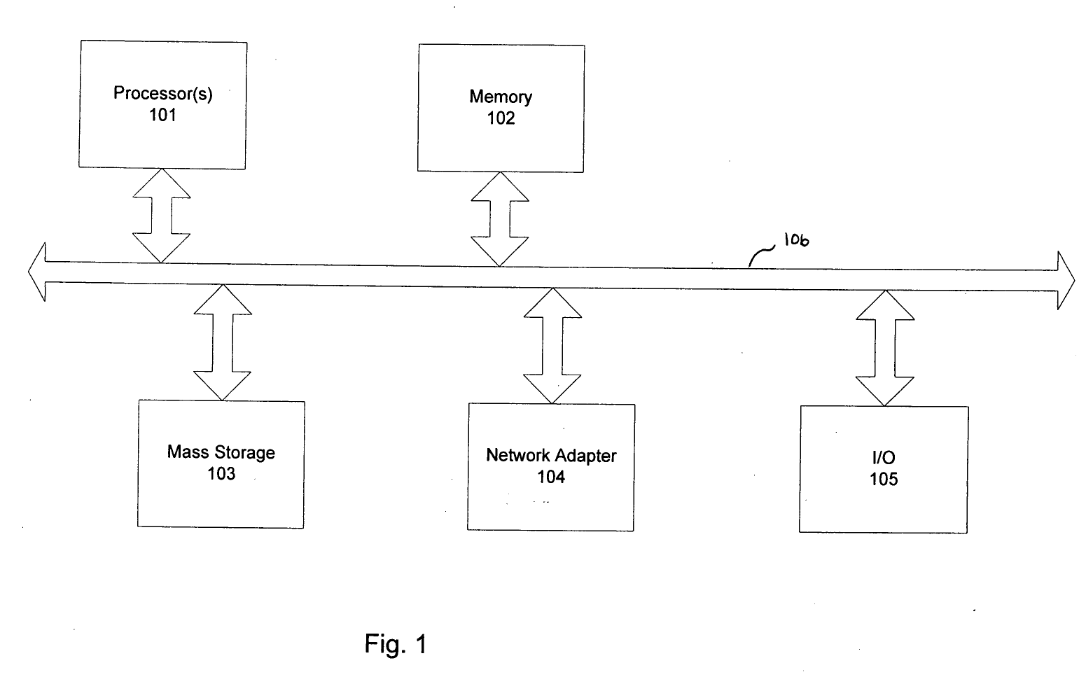

FIG. 1 is a high-level block diagram showing a basic computer system that can be used either as a server or a client (i.e., a target computer) in a searchcasting system such as described below. The illustrated system includes processor(s) 101, i.e. a central processing unit (CPU), memory(s) 102, and, which may be coupled to each other by a bus system 106. The bus system 106 includes one or more buses or other connections, which may be connected to each other through various bridges, controllers and/or adapters, such as are well-known in the art. Also coupled to the bus system 106 are mass storage(s) 103, Input/Output device(s) 105 and network adapter(s) 104. It will be understood that the system may include other conventional devices that are not germane to this description and which are not shown, as it is not necessary to show all in order to understand the present invention.

Note that the clients or target “computers” are described herein as being conventional PCs to facilitate description. However, they could instead be or include essentially any one or more other types of processing or communication devices. For example, one or more of the clients or target “computers” might be personal digital assistants (PDAs), mobile (e.g., cellular) telephones, two-way pagers, and other similar devices. Hence, the term “computer” is used broadly herein to mean any type of processing or communication device that can receive, transmit, store and process information and otherwise perform the processes described herein.

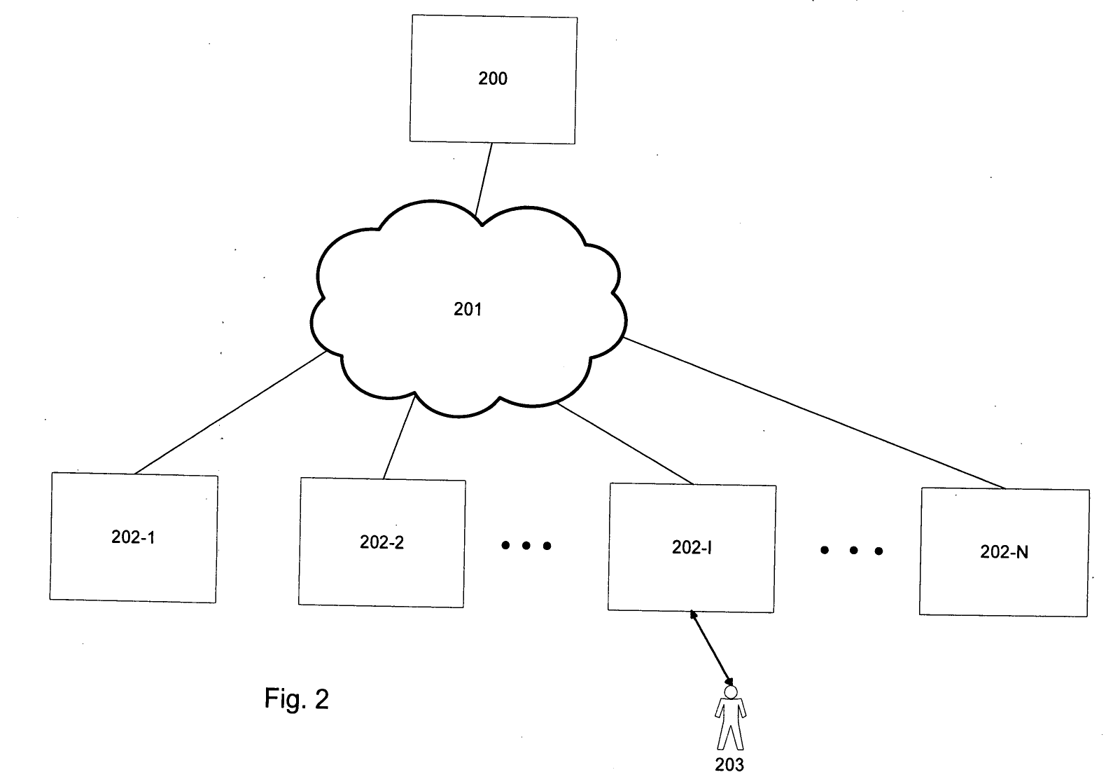

“Searchcasting” is a term used herein to describe the process by which users initiate federated search for “unpublished” information on multiple target computers via a network. The term “searchcasting” is used in this document without derogation of any trademark rights of Tacit Software, Inc. which may exist in this term. In an embodiment of the invention, searchcasting is implemented on an architecture such as illustrated in FIG. 2, which includes a searchcasting server 200 and a plurality of computers 202-1-202-N (i.e., PCs) distributed on a network 201, which may be a local area network (LAN), a wide area network (WAN), a metropolitan area network (MAN), a global network such as the Internet, etc., or any combination thereof.

Searchcasting with Client Side Step-down Auction

In an embodiment of the invention, the searchcasting process begins when a user 203 (hereinafter “the querying user”) of a client computer 202-I initiates a query to search for content, knowledge, relationships, answers or other information stored on other client computers 202 (hereinafter “target computers”) and controlled by users of those computers (hereinafter target users). The querying user can do this by using a traditional search input field on a corporate portal, Web page, or a desktop search bar. The querying user may then be asked to identify a target group he wants to search (e.g., the entire company, just the engineering department, all computers which subscribe to the searchcasting server 200, etc.), a deadline for an answer, and the types of content sought, etc. This query is then sent to the searchcasting server 200 from the querying user's computer 200-I via the network 11. In some embodiments of the invention, the querying user must be authenticated first by logging-in to the searchcasting system. The system, however, may allow anonymous users to conduct a search in limited ways. Such limitations will be addressed in the following discussion.

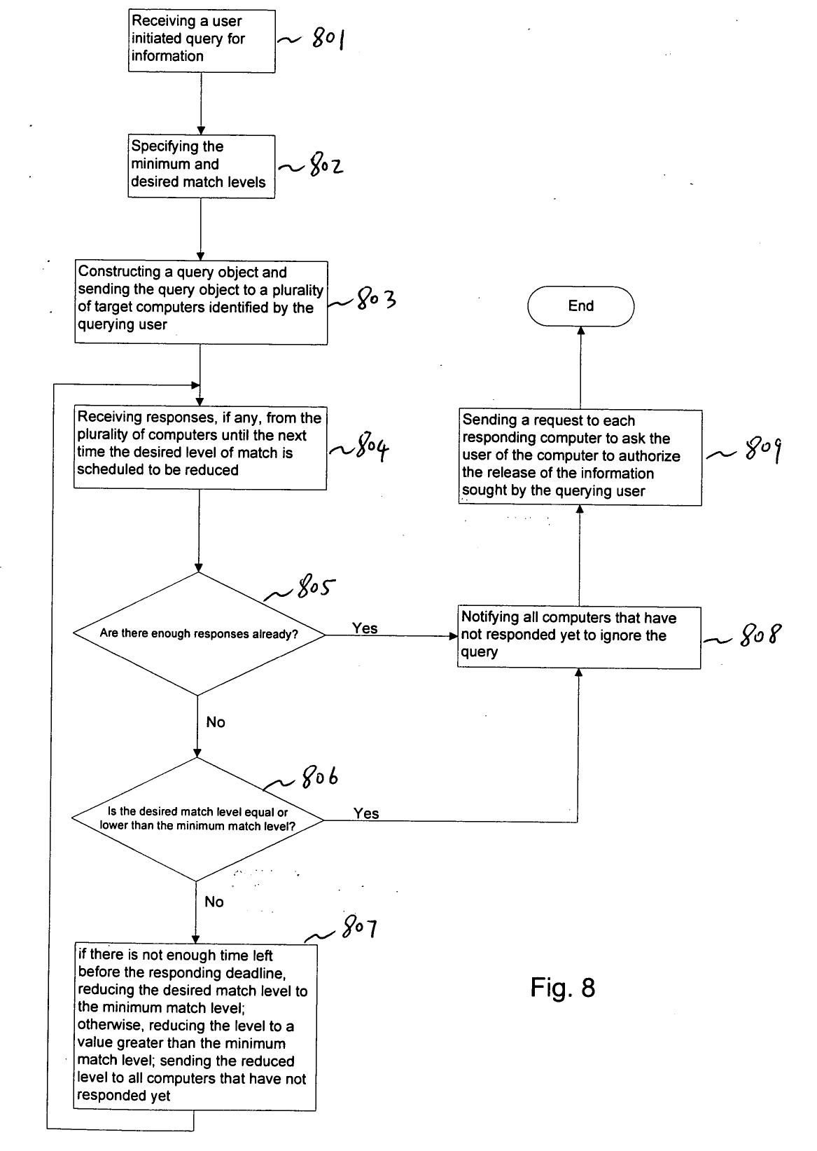

FIG. 8 illustrates what happens next on the searchcasting server. The searchcasting server first receives the query initiated by the querying user at block 801. Then, the searchcasting server 200 specifies a minimum match level and a desired match level for this particular query at block 802. The minimum/desired match level defines the minimum/desired requirements for matching the query in terms of three measures: 1) how well the target user should know the querying user, 2) how well the content on the target user's PC should match what the querying user is looking for, and 3) how well the overall knowledge base of the target user should match the subject matter of the query. Of course, other measures may be used for the matching purpose (i.e., how much the target user is interested in the subject matter of the query); the above description is only one way of implementing the matching standard. In addition, the present invention may also be used in a financial transaction situation, where a query stands for a product or service, for example for a car for sale, and the minimum and desired matching strengths are expressed in dollar amounts. Note that if a querying user is an anonymous user, the measure of how well the target user knows the querying user cannot be obtained; in this case, the searchcasting process should be modified accordingly to accommodate such situation.

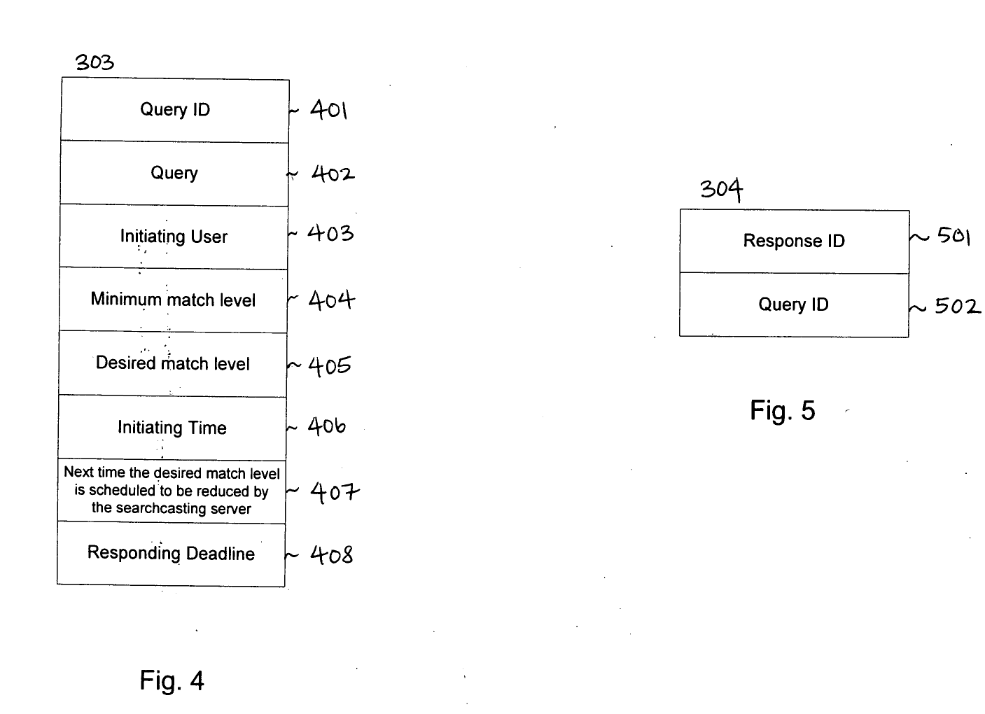

At block 803 of FIG. 8, a query object is constructed and sent via the network 201 to all of the computers in the target group, e.g., one or more of computers 202. FIG. 4 illustrates an example of the structure of a query object 33. A query ID field 401 is assigned as an identification number for this particular query. The query ID field 401 may also be used to identify the querying user's computer. The query field 402 contains the subject matter of the query. Initiating user field 403 includes information such as the querying user's email, identity, etc., such that the strength of relationship between a target user and the querying user may be calculated by a target computer. The minimum and desired match level fields 404 and 405, respectively, are included as well so that a target computer may compare the match with these levels (a detailed process of the comparison will be discussed below for the process on the target computer). Of course, if the desired match level is set too high, few matches on the target computers may result. Thus, the searchcasting server may periodically reduce the level to increase the number of matches. Initiating time field 406 contains the time when the query is initiated. Responding deadline field 408 contains the time by which release of the information sought by the querying user should be authorized, if ever, by a target user. The time slot field 407 represents the time when the searchcasting server is scheduled to reduce the desired match level next time.

Referring again to FIG. 8, at block 804, the searchcasting server 200 starts receiving responses, if any, via the network 201 from the target computers to which the query object has been sent (at block 803). Of course, it is not a certainty that any response will be received, unless the process is implemented to require a response from each target computer even without a match. By the time the desired match level is scheduled to be reduced, if there are enough responses received already (determined at block 805), the searchcasting server 200 notifies all target computers that have not responded yet to ignore the search (at block 808). Otherwise, the desired match level needs to be reduced. But if the desired match level has already been reduced to the same to the minimum match level (at block 806), the searchcasting server 200 simply accepts the responses it already received and notifies all target computers that have not yet responded to ignore the query. If the desired match level can still be reduced without being lower than the minimum match level, then a reduced desired match level is broadcast to all target computers that have not yet responded at block 807, and the process loops back to block 804 to start receiving new responses if there are target computers which have matches meeting the newly reduced desired match level. However, also at block 807, if there is not enough time left before the responding deadline, the desired match level is reduced to the same to the minimum level. The purpose is to leave enough time to a target user to act before the responding deadline. However, what constitutes enough time before the responding deadline depends on different situations. For example, if the target of a query submitted during working hours is a group of corporate employees who are always on their computers during working hours, then their responding speed should be fairly quick. However, if everything is the same except that the query is submitted after working hours, responses will not be received from those employees who have off their computers and gone home. Thus, a simple formula could be used to determine how much time should be left before the responding deadline. The formula may take into consideration of the factors such as the scope of the target group, the query's initiating time, etc.

After the iteration finishes at block 808, the searchcasting server 200 sends a request message to each responding target computer 202 via the network 201 at block 809. Alternatively, the request message may be sent to each responding target computer immediately upon the receipt of each of the target computers' response. The request message will cause the responding target computer to display a dialog box or other form of I/O interface, prompting the user of the target computer to authorize (or deny) the release of the information which was found to match the query on that user's computer. The dialog box will also inform the user of the identity of the target computer who is seeking the information, thus enabling the user of the target computer to make an informed decision whether to authorize or deny the release of the information.

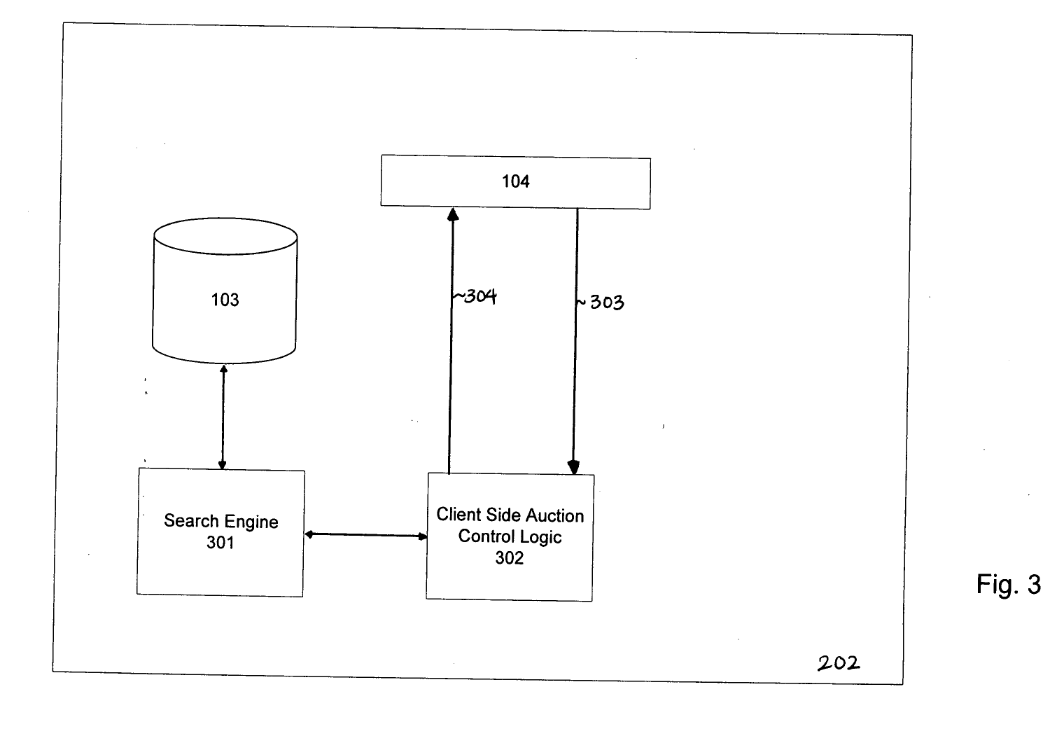

The above describes an example of the server side process, i.e., the process on the searchcasting server 200. A corresponding client side process is also implemented on each target computer 202 to coordinate with the server side process to accomplish the overall searchcasting process. FIG. 3 is a block diagram illustrating how the relevant components on a target computer 202 interact. The mass storage 103 stores information that is indexed and searchable by a local desktop search engine 301, e.g., Google's desktop search engine, Microsoft's desktop search engine, or a search engine developed specifically for the searchcasting process. A Client Side Auction Control Logic (CSACL) 302 is coupled with the search engine 301. Through the network adapter 104, the CSACL 302 communicates with the searchcasting server 200 across the network 201 (shown in FIG. 1). The query object 303 constructed by the searchcasting server 200 is received and processed by the CSACL 302. The desktop search engine 301, CSACL 302 and network adapter 104 each may be implemented in software, in special-purpose hardwired circuitry, or any combination thereof. The mass storage 103 may be, for example, a conventional hard disk drive or other similar storage facility.

FIG. 6 illustrates an example of the process on the CSACL 302. When the CSACL 302 receives a query object from the searchcasting server at block 601, it will check, at block 602, whether the responding deadline has passed. If so, the query object is ignored. This can happen when the target computer has been turned off or has been off the network since the query was initiated. When the target computer is turned on or is back on the network again, it will download any query objects that have been sent to it since the last time it went off. Thus, some of the query objects could contain a query to which the responding deadline has passed.

If the responding deadline has not yet passed, then at blocks 603-605, the CSACL calculates the three measures of match, namely, 1) how well the user of this target computer (the target user) knows the querying user, 2) how well the content on the target computer matches what the querying user is looking for, and 3) how well the overall knowledge base of the target user matches the subject matter of the search. A detailed calculating process is discussed below. Note that a target computer may have documents having different levels of content match strength. In this case, only the document (or content) with the highest matching strength would be concerned for searchcasting.

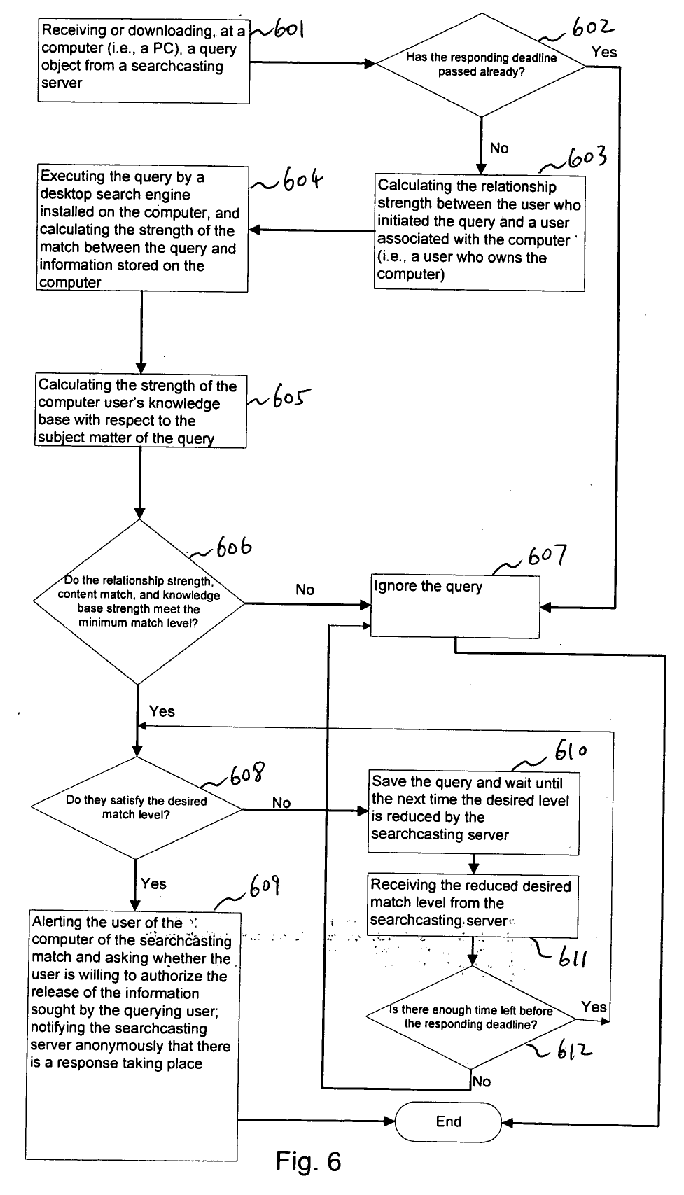

Then, after the three measures are obtained, they are compared with the minimum match level at block 606. The minimum and desired match levels may be implemented, for example, as three-dimensional vectors, each vector containing the minimum/desired requirement for the three matching measures. Thus, the comparison of each measure with the minimum/desired match level is to compare each measure with the value of the corresponding vector dimension. There are, however, other ways of implementing the minimum and desired match levels, i.e., a single value obtained by combining the three measures in accordance with a function or formula. As it is well within the knowledge of an ordinary skilled in the relevant art, further discussion with respect to this feature is not necessary to understand the present invention. Back to the discussion of block 606, if the three measures do not meet the minimum match level, the search is ignored directly at block 607, and no response is sent to the searchcasting server from the target computer. Otherwise, they are compared with the desired match level at block 608. If the desired match level is met, the CSACL 302 displays a dialog box to alert the target user that information on his computer has been matched through searchcasting and asks the user to either authorize the release of the information to the querying user or to deny the release before the responding deadline (at block 609). At the same time, the CSACL 302 sends the searchcasting server 200 an anonymous response message, providing the searchcasting server 200 a basis to decide whether or not to reduce the desired match level. As illustrated in FIG. 5, an anonymous response 304 contains a response ID and the query ID so that the server may identify from which target computer the response comes and to which query the anonymous response is responding. Note that, alternatively, if the target user is not working on the computer at the time the match occurs, an email message may be sent to the user to alert the match. Alternatively, the anonymous response may be sent to the searchcasting server first. Upon the receiving of the anonymous response, the searchcasting server determines, based on the reactions from other target computers, whether the specific target computer should be permitted to alert its user. If so, a request message is sent to the specific target computer, and the target computer, upon receiving such request, alerts its user of the match.

On the other hand, if the three measures fall between the desired level and the minimum level, the target computer saves the search and waits until the next time the desired match level is reduced by the searchcasting server 200 (at block 610). After receiving the newly reduced desired match level (at block 611), if there is still enough time left before the responding deadline of the search, the process loops back to block 608 to check whether the three measures meet the newly adjusted desired match level; otherwise, the target computer ignores the query at block 607.

Note that, alternatively, a query object may be sent as an email to a target user if the user's computer is temporarily turned off. When the user turns on the computer and checks his email, the query object is detached from the email and processed by the CSACL 302.

In an alternative embodiment, the task of periodically reducing the desired match level may be totally performed at the target computer. According to this embodiment, the data structure of a query object is adapted to include a detailed schedule and a formula to reduce the desired match level. Each target computer assumes the task of periodically reducing the desired match level according to the schedule and the formula. In case the searchcasting server has already received enough responses from target computers, the server informs all target computers that have not responded yet to ignore the query.

This alternative embodiment does not require communication between the searchcasting server and the target computers during the process of auction; thus, this embodiment ensures that no information leaves a target computer until the user of that computer allows it.

In an embodiment of the invention, a user may specify one or more personalized match measures for a query and desired match level for each measure. If the personalized measure(s) of a query received at his computer meets the level(s), he will be alerted immediately by the computer. For example, the user may specify that as long as the subject matter of a query is about “fruit”, he should be alerted immediately. Upon such alert, he may choose to respond to the querying user by allowing the computer to send a message, for example, saying “I am interested in this topic, too; would you mind if I contact you with respect to this topic?” Thus, a user in the searchcasting community may keep track of some topics he is interested in even without submitting a query with respect to the topics.

Calculation of the Three Measures

1) Strength of Content Match

The strength of content match between information stored on a target computer and a query may be handled by calling the desktop search engine to search the entire data stored on the computer. Most desktop search engines provide some form of a confidence score for the search, and the confidence score may be a proxy for the strength of content match.

However, different desktop search engines have different relevance metrics and some do not even expose the relevance metrics at all. Thus, the following algorithm may be used as an alternative.

To understand the algorithm, the following concepts need to be introduced first:

(a) Clause

Search expressions can be broken down into pieces, or clauses. Each clause is either a keyword or a phrase. The search expression “oracle database” timeout jdbc “sql db repository” can be decomposed into the following clauses (see Table 1):

TABLE 1

| Clause | Type | Length |
|---|---|---|
| oracle database | phrase | 2 |
| timeout | keyword | 1 |
| jdbc | keyword | 1 |
| sql db repository | phrase | 3 |

(b) Phrases are Better than Keywords

It is much more significant to match a phrase than an individual keyword. Matching a longer phrase is better than matching a shorter phrase. Clauses need to be weighted according to their intrinsic value. To express the better value of phrases and length in formulae, the following parameters are defined:
PHRASE_{—FACTOR=}2
WEIGHT(keyword)=1
WEIGHT(phrase)=PHRASE_FACTOR*length

The clauses in our example would be ranked by weighed as follows (see Table 2):

TABLE 2

| Clause | Length | Weight |
|---|---|---|
| sql db repository | 3 | 6 |
| oracle database | 2 | 4 |
| timeout | 1 | 1 |
| jdbc | 1 | 1 |

(c) Title Matches are Significant

One crucial piece of information all desktop search engines provide is the title (i.e., the filename) of matching documents. If each clause is matched to the title, it may be determined whether any of the clauses are in the title. Title matches are significant. For example, a document matching 3 clauses and the title is probably better than a document matching 4 clauses but not the title. That is, a title match may marginally make up for missing a small number of clauses.

(d) Breadth is Key

The higher the number of clauses are matched with a document, the higher the matching strength is. For example, a document that only matches one clause may have a lower matching strength than a document that matchs three clauses. Thus, the formula should take breadth into account, that is, the number of matching clauses is significant in terms of determining the strength of a match. Match score is divided in bands. For example, with 4 clauses, scores may be divided into 4 different bands. But bands may not be all equal. Using the clause weights described above, the relative size of each band may be calculated:
TOTAL_WEIGHT=SUM(WEIGHT(clause))
BAND_WEIGHT(clause)=WEIGHT(clause)/TOTAL_WEIGHT

TABLE 3

| | | Band |
|---|---|---|
| Clause | Weight | Weight |
| sql db repository | 6 | 50% |
| oracle database | 4 | 33% |
| timeout | 1 | 8% |
| jdbc | 1 | 8% |

Note that in Table 3, clause jdbc has a band weight of 8%. This means that matching only the keyword jdbc can only result in a very low match: at most an 8% score.

(e) Minimum Specificity Required

Experience with desktop search engines shows that one keyword searches result in poor document matches. The algorithm will work in this case, but work best when several clauses (in phrase) are provided. Thus, the searchcasting portal may warn a querying user that a single keyword search is too little for searchcasting purposes. Additionally, if the user types a disconnected set of keywords, they may be proactively turned into a set of clauses. For example, if a querying user submits a query for “oracle database systems”, it may be breaken up into a few clauses:
“oracle database systems”
“oracle database”
“database systems”
oracle
database
systems

These clauses will provide much more granular results than the original.

(f) Break Ties Using Native Relevance

Some desktop engines do provide a notion of relevance. Microsoft desktop search engine returns a relevance score. Google's desktop search engine only returns rank information. When all things are equal, boost strength using rank or native relevance score. For example, if 4 documents all match the 4 clauses in one case, and none of the clauses is in the title, then do not return the same score for them. Instead, boost the top documents within the range using the native relevance measure.

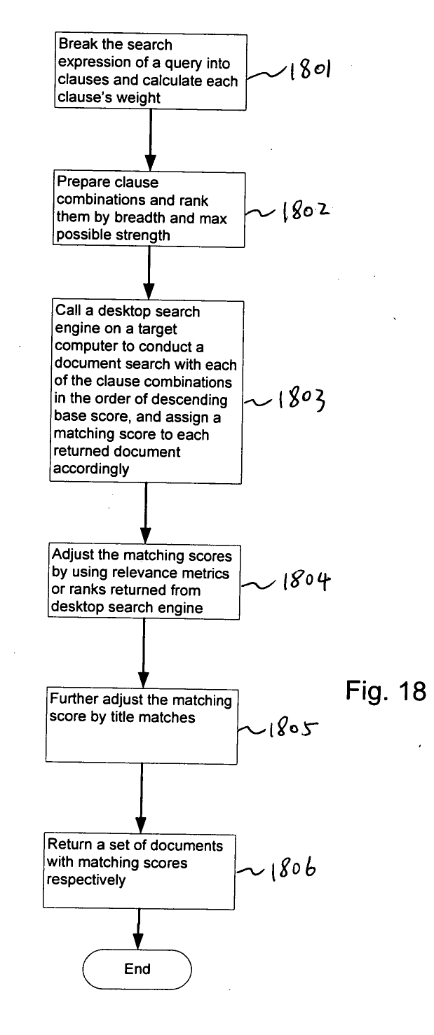

FIG. 18 is a flow chart which illustrates the algorithm to calculate the strength of a content match. At block 1801, the search expression of a query is breaken into clauses and each individual clause's weight is calculated (see tables 1 and 2 above for example).

Then, at block 1802, the process prepares clause combinations and ranks them by breadth and max possible strength. For each combination, the base score is the sum of the clause weights of the clause combination divided by the total clause weight sum of the query (see Table 4 for example).

TABLE 4

| | Num | Total | Base Score |
|---|---|---|---|
| Clause Set | Clauses | Weight | (%) |
| “oracle database” timeout jdbc “sql db | 4 | 12 | 100 |
| repository” | | | |
| “oracle database” timeout “sql db | 3 | 11 | 92 |
| repository” | | | |
| “oracle database” jdbc “sql db | 3 | 11 | 92 |
| repository” | | | |
| “oracle database” “sql db repository” | 2 | 10 | 83 |
| “sql db repository” timeout jdbc | 3 | 8 | 67 |
| “sql db repository” timeout | 2 | 7 | 58 |
| “sql db repository” jdbc | 2 | 7 | 58 |
| “oracle database” timeout jdbc | 3 | 6 | 50 |
| “sql db repository” | 1 | 6 | 50 |
| “oracle database” timeout | 2 | 5 | 41 |
| “oracle database” jdbc | 2 | 5 | 41 |
| “oracle database” | 1 | 4 | 33 |
| timeout jdbc | 2 | 2 | 17 |
| timeout | 1 | 1 | 8 |
| jdbc | 1 | 1 | 8 |

Next, at block 1803, the process calls a desktop search engine on the target computer to conduct a document search (or content search) with each one of the clause combinations in the order of descending base score. For example, in table 4, the first clause combination used for a search will be clause “oralce database” timeout jdbc “sql db repository”, which has a base score of 100%; and the second one will be either “oracle database” timeout “sql db repository” or “oracle database” jdbc “sql db repository”, both having a base score of 92%. For those documents (or results) returned for a particular clause combination, the matching score may be the clause combination's base score. If enough results have been returned, then the search may be terminated immediately before all of the clause combinations are evaluated.

Then, at block 1804, tied matching scores are adjusted by using relevance metrics or ranks returned from desktop engines. For example, the algoritm first searches for the clause combination with the 100% base score. If it gets results, all those files start with a 100% matching score. In order to further differentiate them appart, their matching scores are adjusted by the native relevance metric as follows:
The possible range of values is between the base score and the next possible different score. In the example shown in Table 4, the first combination scores at 100% and the next one at 92%. Thus, the range is 100% to 92%.
If only rank information is returned from a search engine, distribute all the results evenly across this range. Thus, if there are 4 documents (or results), their scores will be 100%, 98%, 96% and 94%, respectively.
If relevance metrics are returned from a search engine, set the top relevance value to 100% and scale the rest of the documents (or results) linearly by this amount. For example, two documents are returned, one with relevance of 50% and the other one 10%. Then relevance 50% may be scaled into 100%, and accordingly, releance 10% is scaled into 20%. The top match remains at 100% and the next match's score is 92%+range*percent=92%+8*0.2%=93.6%.

At block 1805, scores are further adjusted by title matches. As mentioned earlier, title matches are significant, and matching phrase clauses in the title even more so. In this step, the process checkes the clauses against the title string of a document to see if there's a match. If there is, the matching score of the particular document may be significantly raised. This operation may cause a result to transcend its original base score (but may be capped at 100%).

Finally, at block 1806, a set of documents (results) with matching scores with regard to a query is returned. Note that, as discussed above, for searchcasting purpose, only the document (or result) with the highest matching score may be concerned. Thus, for effeciency reasons, as soon as the match with highest score is found, the above algorithm may terminate right away.

2) Relationship Strength

Relationship strength between a user of a target computer and a querying user may be calculated with the help of the desktop search engine. For example, the CSACL on a target computer calls the desktop search engine to do a query on a database of all of the emails to and/or from the user, to try to find out whether the user has directly communicated with the querying user before (i.e., emails have been sent to or received from each other). If so, there is a direct relationship. Depending on how frequent and recent these email communications were, a strength score may be given to the relationship.

If, however, there is no direct communication, then the two users have no direct relationship. They may, however, have exchanged emails by “cc” to each other, or mentioned each other's name in the body of the email, thus, establishing an indirect relationship. Of course, the strength of an indirect relationship is less than the strength of a direct relationship.

3) Knowledge Base Strength

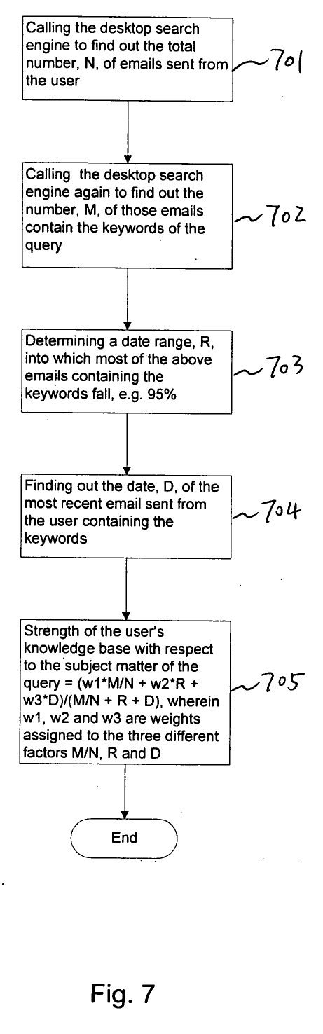

FIG. 7 is a flow diagram showing a process of calculating a strength of knowledge base of a user of a target computer with respect to a subject matter of a query. At block 701, at a target computer, the CSACL calls the desktop search engine to find out the total number, N, of emails sent from the user. The CSACL then calls the desktop search engine again to find out the number, M, of those emails contain the keywords of the query at block 702. Then, at block 703, the CSACL determines a date range, R, into which most of the above emails containing the keywords fall, e.g. 95%. At block 704, the CSACL finds out the date, D, of the most recent email sent from the user and containing the keywords. Thus, the strength may be calculated, for example, according to the formula below:

Strength of the user's knowledge base=(w1*M/N+w2*R+w3*D)/(M/N+R+D), wherein w1, w2 and w3 are weights assigned to the three different factors M/N, R and D. The first factor M/N roughly represents how much attention the particular user has devoted to the subject matter of the query during the past. The second factor R roughly represents how long the user devoted his attention to the subject matter during the past. The third factor D roughly represents how recently the user was devoting his attention to the subject matter. Thus, based on the three factors, the strength of the user's knowledge base with respect to the particular subject matter can be estimated. The principle is that the longer, more recently, and more frequently a user has worked on a particular subject matter, the stronger his knowledge base with respect to the subject matter should be.

Note that there are many possible ways to obtain the three measures described above. The above discussion only illustrates one such way.

Searchcasting with Robust User Privacy Protection

In certain embodiments of the invention, in order to address the issue of users' privacy concerns, no information (even the fact that a searchcasting match has taken place) will be sent to the searchcasting server from a target computer until a user of the target computer authorizes it. In addition, the number of users who are to be alerted of a searchcasting match of a query generally should be limited as much as possible.

In an embodiment, the searchcasting server starts out by looking for responses at a high desired match level. To avoid the possibility of bothering a lot of computer users who all match a query at a high level, only a small number of target computers are allowed to alert their users immediately upon a match satisfying the current desired match level at first. If the searchcasting server does not receive any responses within a short period of time, it expands the-group of eligible target computers. As time passes without any response at a high desired match level, the size of the group of eligible target computers expands exponentially. This is called the “expansion” process. If there are no responses and the group of eligible computers includes the entire target group that is currently online, the server knows there is no one who is going to respond at the current strength level. The next step is for the searchcasting server to lower the desired match level (“decay”) and start a new cycle again. The new cycle repeats the expansion process again with a lower desired match level. If the eligible target computers expands to once again include entire target group currently online and no one (or too few) responds within the allotted time, the desired match level is decayed and the expansion process begins anew.

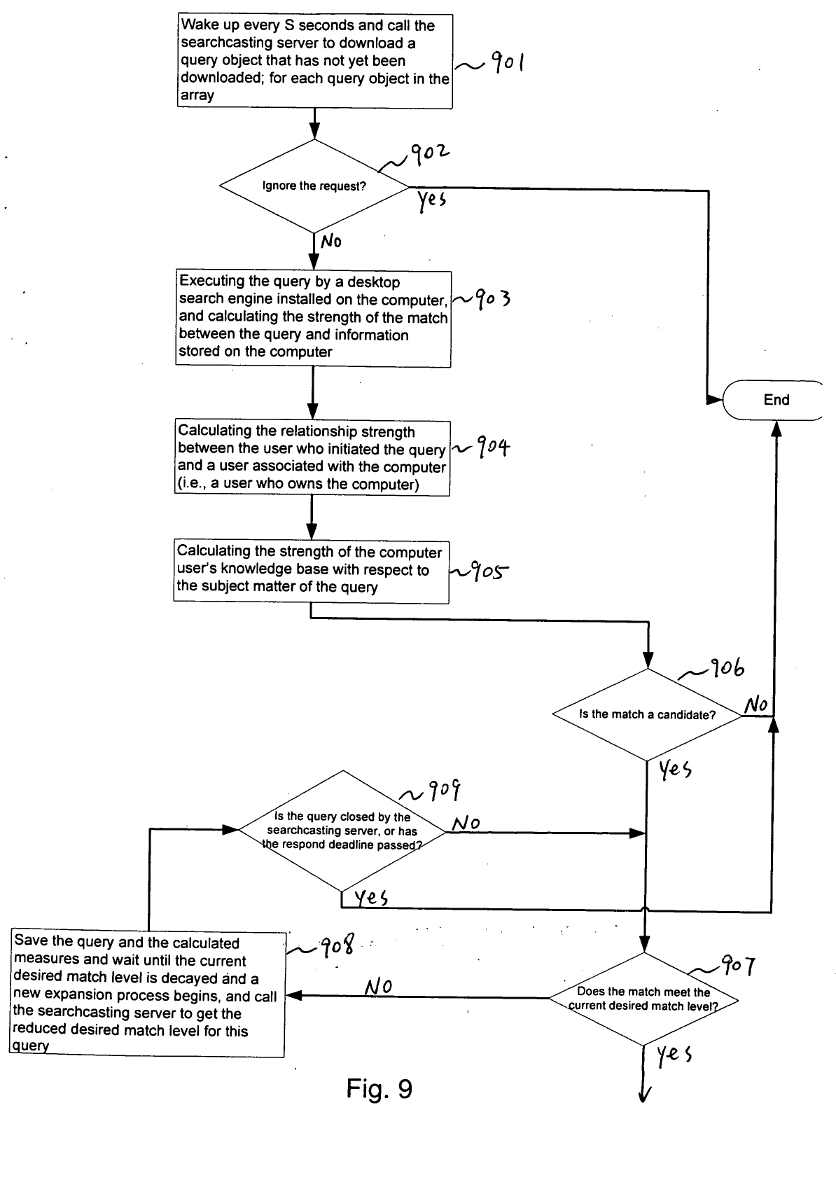

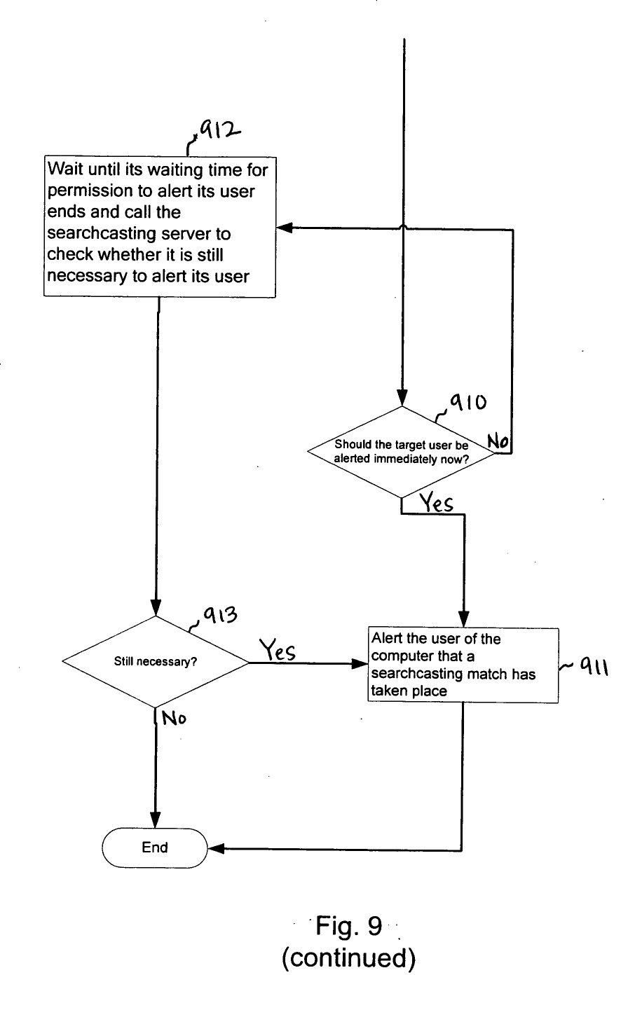

FIG. 9 illustrates the above process in detail on a target computer. At block 901, the target computer wakes up every S seconds (configurable depending on how realtime need is and how much network traffic is generated) and calls the searchcasting server to download an array of query objects that have not yet been downloaded. Each query object is then processed one by one, by the process follows. At block 902, the target computer decides if it is going to immediately ignore the query request. It might ignore the request because its user has chosen to ignore the particular subject area of the query. There may be other reasons why the request will be ignored. As long as these reasons do not expose any private information about the user, the target computer can send an ignore message back to the searchcasting server. This allows the searchcasting server to update its statistics and give immediate feedback about the query back to the querying user.

If the query request is not ignored at block 902, the target computer will calculate the three measures (strength of content match, strength of relationship and strength of knowledge base) at blocks 903-905. At block 906, the three measures are compared with the query's minimum match level. If they satisfy the match level, the match is considered as a candidate; otherwise, the query is ignored immediately. Then, at block 907, the three measures are compared with the current desired match level. If they do not satisfy the current desired match level, the process goes to block 908, where the query and the three calculated measures are saved and put to a waiting status until the current desired match level is decayed and a new expansion process starts. When the time comes, still at block 908, the target computer calls the searchcasting server to get the newly reduced desired match level. Then, at block 909, the process determines whether the query has been closed or the responding deadline has passed. If so, the query is immediately ignored; otherwise, the process goes back to block 907, where the three measures are compared with the newly reduced desired match level. A query may be closed for any of the following reasons:
1) closed by the querying user;
2) closed because there have already been too many responses;
3) the responding deadline has passed; or
4) the last decay and expansion process has finished.

Note that the above list is not an exhaustive list. There may be other reasons the query may be closed by the searchcasting server.

On the other hand, at block 907, if the three measures satisfy the current desired match level, then the process goes to block 910, where it is determined whether the target computer is allowed to alert its user immediately. Whether a target computer is allowed to alert its user immediately upon a match satisfying the desired match level is controlled by the searchcasting server's expansion process. When a query object is downloaded by a group of target computers, the searchcasting server decides, for each target computer, how long it needs to wait before it can alert its user of a match satisfying the current desired match level during this decay cycle. For example, the first few target computers to download the query are allowed to immediately alert their users if they have such a match. Later target computers are given a longer waiting time to avoid having a lot of target computers alerting their users at the same time. As discussed earlier, the number of target computers allowed to alert their users at any one time may increase exponentially. Let's say the first 5 target computers are allowed to immediately raise an alert. The next 15 target computers might have to wait two minutes and check back with the searchcasting server before raising any alert. If the searchcasting server already received enough responses from the first 5 target computers, maybe there is no need to have the additional target computers raise alerts any more. The next 60 target computers might be told to check back in 4 minutes instead of 2 minutes. The next 240 target computers might be told to check back in 6 minutes, and so on. Suppose there are still 60 minutes before the responding deadline, each decay cycle takes 10 minutes, and a user should be given two minutes to respond to an alert. This means that there will be 10/2=5 expansions of the size of the eligible group. The formula for determining the number of eligible target computers in each expansion may be 5*2²ⁱ⁻¹ where i is the iteration number of the expansion. This means the first batch has 5 eligible target computers. In two minutes, there will be 20 eligible target computers. In another two minutes the number jumps to 80, then to 320, and finally to 1280 (or the whole group, if there are more than 1280 online target computers).

Back to FIG. 9, at block 910, if the target computer is allowed to immediately alert its user, then the user is alerted, for example, by a dialog window (similarly as discussed in the previous embodiment) at block 911. On the other hand, if the target computer is not allowed to immediately alert its user, it will wait until its specified time for permission to alert its user ends, and may call the searchcasting server to check whether it is still necessary to alert its user (at block 912). If so (at block 913), it will immediately alert its user at block 911; otherwise, the query is ignored and the process ends.

In an embodiment, the desired match level of a query may be periodically reduced by the searchcasting server. It starts at a high value and decays in increments if the searchcasting server doesn't get any responses from users at a high level. The decay step size may be determined by dividing the total range of acceptable values (initial desired match level—minimum match level) into equally sized buckets. The number of buckets may be determined by dividing the total amount of time left before the responding deadline by the amount of time needed for a decay cycle. The amount of time needed for a decay cycle may be a predetermined value (i.e., 10 minutes), or it may be determined based on other factors such as the network speed, number of computers in the target group, etc. Suppose 10 minutes is to be used for each decay cycle for the particular query. This means that within 10 minutes, every available target computer will get a chance to raise an alert to its user if there is a match satisfying the current desired match level. If the total amount of time left before the responding deadline is one hour (60 minutes), there are 6 available buckets of ten minutes each. If the minimum match level is 30 and the initial desired match level is 100, the total range of acceptable values is 70. In this example, each time the desired match level is decayed, it drops by 70/6 points.

As discussed above, if the match at a target computer does not meet the current desired match level, the target computer put the query into waiting status until the desired match level is decayed, and then the target computer calls the searchcasting server to update the query status, including the reduced desired match level.

Searchcasting with Server Side Auction

In another embodiment of the invention, an auction process is implemented on the searchcasting server 200 to identify the N-best matches of the query. FIG. 12 illustrates a searchcasting server 200 which has an auction logic 1201 controlling the auction process. Similar to an embodiment discussed above, the process begins when a querying user initiates a query and is asked to identify the target group, a deadline for an answer, and the types of content sought, etc. This query is then sent to the searchcasting server 200 from the querying user's PC via the network 201. Again, in certain embodiments a querying user must be authenticated first by logging-in to the searchcasting system. Anonymous users, however, are allowed to conduct a limited search.

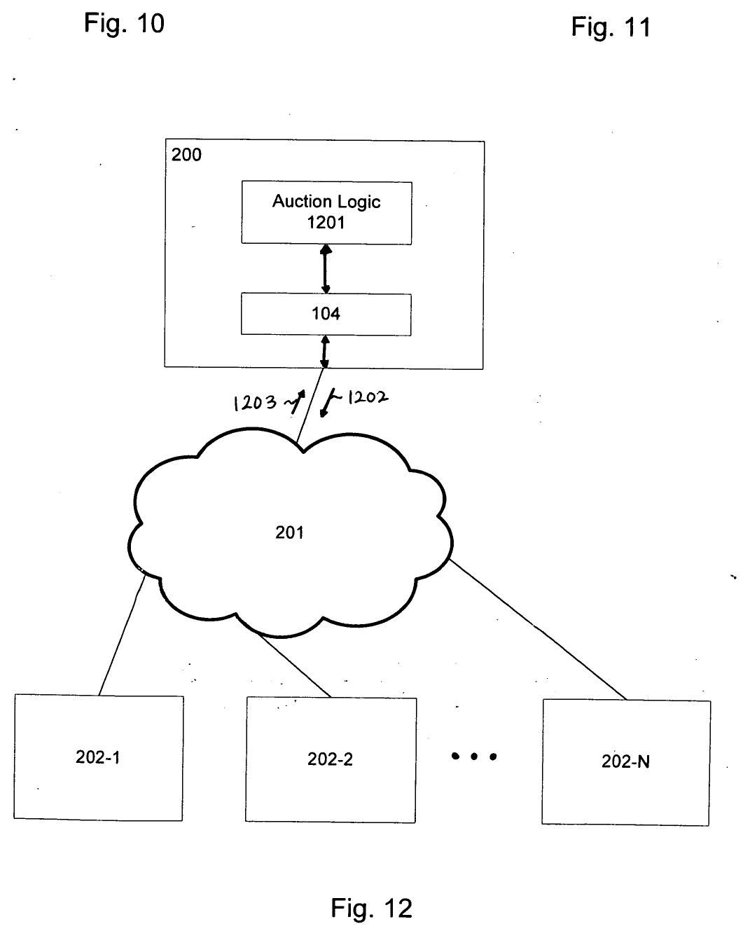

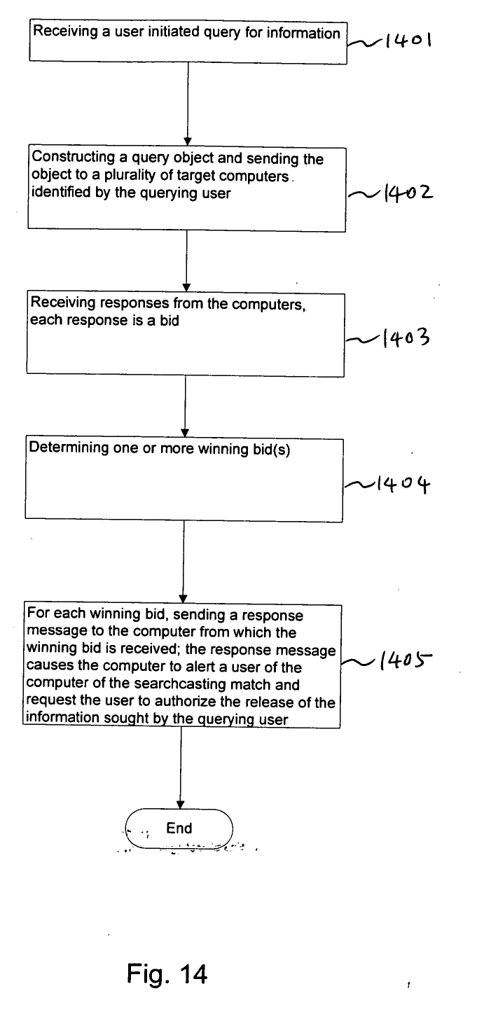

FIG. 14 illustrates an example of the auction process in detail. At block 1401, the searchcasting server 200 receives a search request. At block 1402, the searchcasting server 200 constructs a query object. An example of the detailed structure of a query object 1202 is illustrated in FIG. 10. Similar to a query object 303 shown in FIG. 4, a query object 1202 includes aquery ID 401, the query 402, the querying user 403, the initiating time 406, and the responding deadline 408. Then, the searchcasting server sends the query object to the target computers identified as the target group by the querying user. If a target computer receives the query object, it will process it and calculate a bid representing the three measures discussed earlier. Then, the bid is encapsulated in a response, which is then sent to the searchcasting server. As shown in FIG. 11, a response 1203 should at least include a response ID 1101 to uniquely and anonymously identify the responding target computer, the search request ID to which the response is responding, and the three calculated measures: relationship strength 1102, knowledge base strength 1103, and content match strength 1104 (see detailed discussion of the client side process infra).

At block 1403, the searchcasting server receives such responses from the target computers until there are enough responses or until a certain amount of time has elapsed. Then, the auction process logic will process all of the bids received and determine which bid(s) is (are) the winning bid(s) (at block 1404). At block 1405, the searchcasting server sends a request message to each target computer which has a winning bid. The request message will cause the target computer to alert its user to the searchcasting match and ask the user to either authorize the release of the information to the querying user or deny it. As discussed above, the searchcasting server may alternatively send an email to the target user for the same purpose.

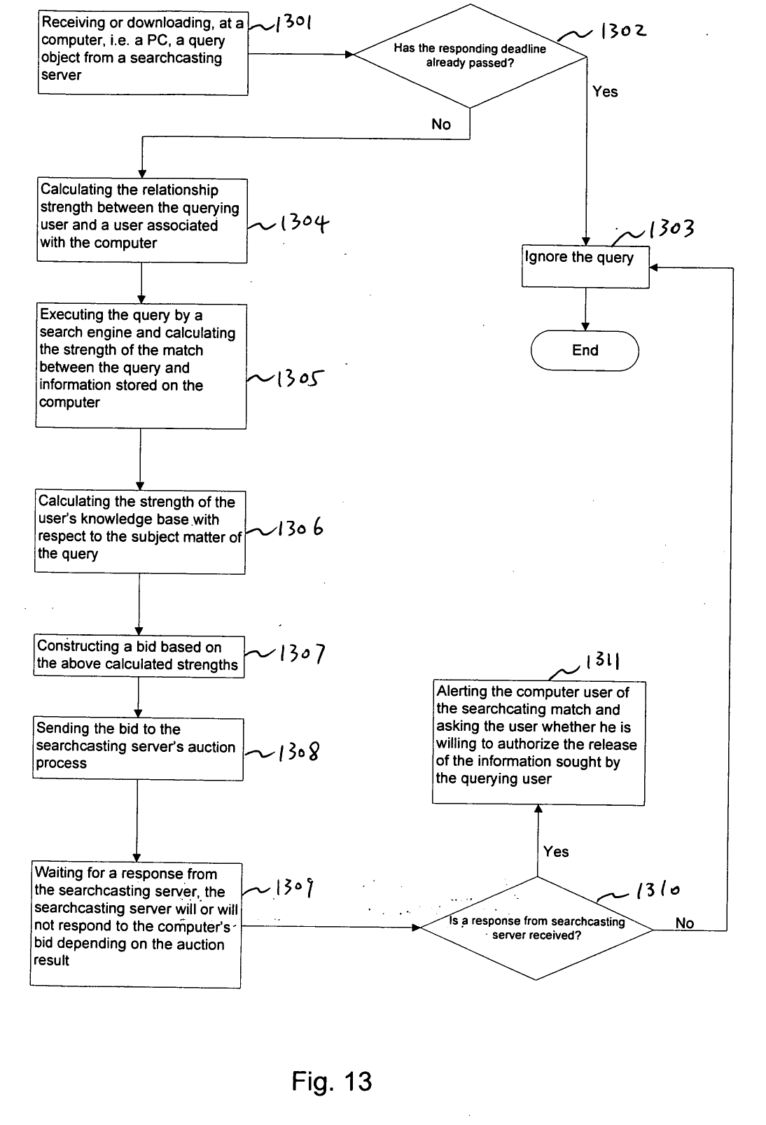

FIG. 13 illustrates the auction process on the target computer side. At block 1301, a target computer receives a query object from the searchcasting server. Since there is a possibility that the target computer was temporarily turned off or off the network when the search was initiated, at block 1302, the responding deadline is checked. If the deadline has passed, then the target computer simply ignores the search at block 1303. Otherwise, at blocks 1304-1306, the target computer processes the search and calculates the three measures discussed above. At block 1307, a bid is created including the three calculated measures, and the bid is encapsulated in a response object as illustrated in FIG. 11 and discussed above. The response object is then sent to the searchcasting server at block 1308. So far, all steps in the process are handled in the background of the computer so that the user is not aware of it. If the bid is a winning bid, the same target computer will receive a request from the searchcasting server. Upon receiving the request, the target computer alerts the user of the searchcasting match, and informs the user the querying user's identity, information sought, and responding deadline. The user of the target computer may either authorize the release of the information sought, or deny it based on the informed information. Similarly, the above process may be implemented by a dialog box displayed to the user when he is using the target computer, or by email if he is temporarily off the computer.

Searchcasting with Server Side User Knowledge Profile Filtering

The embodiments discussed above broadcast the query object to all of the target computers that a querying user identified, i.e., to the target group (which may include all of the computers that subscribe to the searchcasting server 200). However, there are some cases when the search volume is high (for example, within an enterprise), so that some individual target computers will be burdened to just process all of the search requests on the background. Thus, in these situations, it would be desirable to send the query to only a limited number of target computers which are likely to yield highly responsive results.

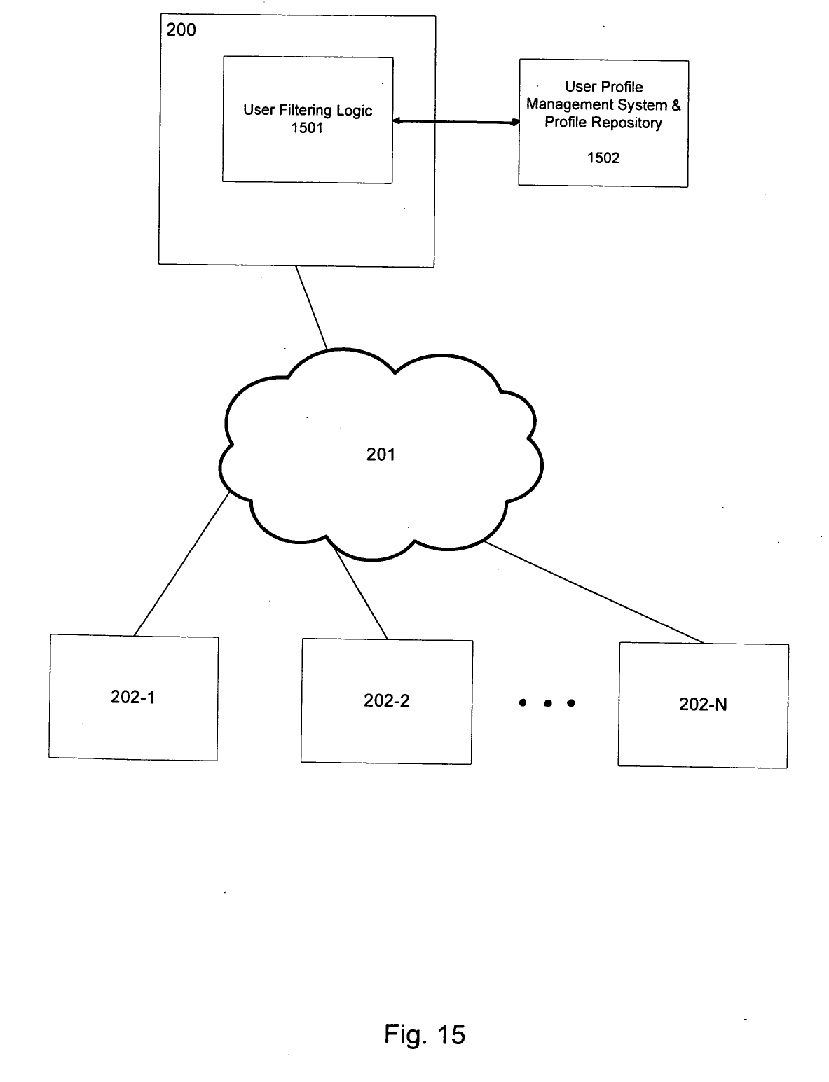

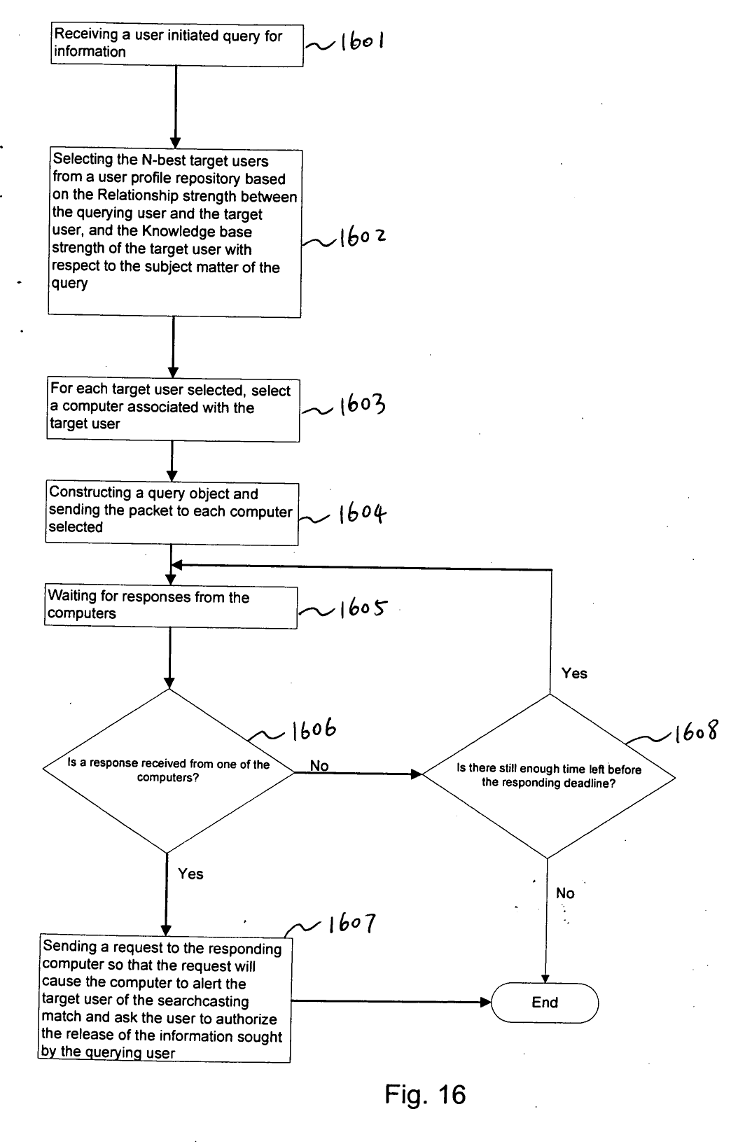

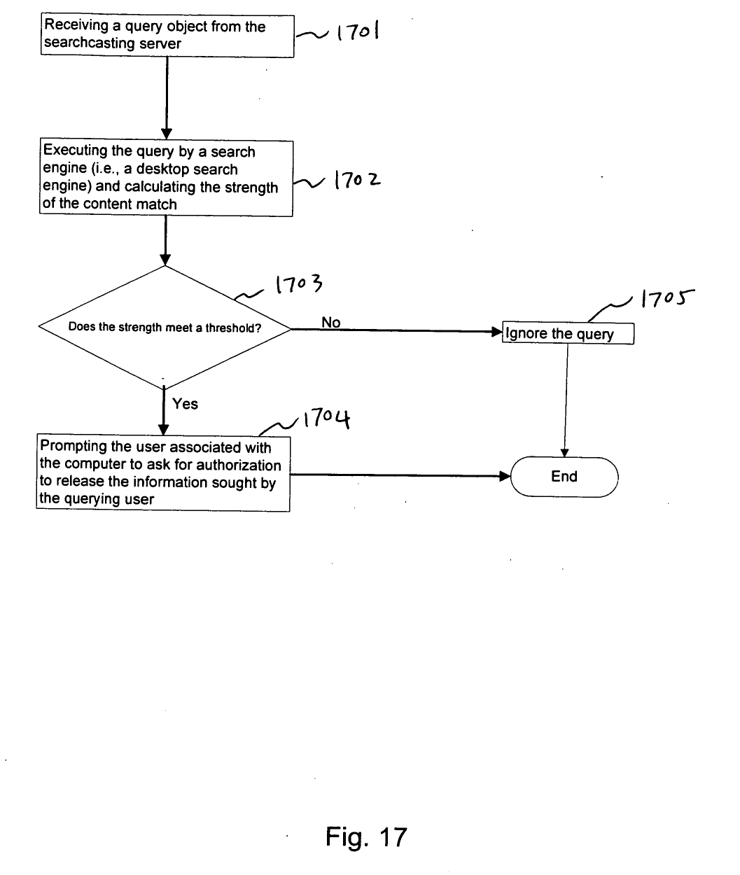

In an embodiment of the invention, as illustrated in FIG. 15, a user knowledge profile system 1502 is coupled with the searchcasting server 200. The user knowledge profile management system 1502 communicates with a user filtering logic 1501 in the searchcasting server 200 (or outside the box) to pick the N-best target users to which a particular search request will be sent. The user knowledge profile management system maintains a separate user profile for the user of each of the client computers 202. Each user profile contains, among other things, information about the corresponding user that represents or is indicative of the knowledge base or information focus of that user (e.g., education, work experience, hobbies and/or interests, etc.). The process is illustrated in FIGS. 16 and 17.

In FIG. 16, at block 1601, the searchcasting server receives a query initiated by a querying user. At block 1602, the querying user's identity and the subject matter of the query are received by the user filtering logic. The user filtering logic then communicates with the user knowledge profile management system, to cause the user knowledge profile management system to select the N-best target users based on the query and the stored user profile, i.e., the N users who have the closest relationships with the querying user and each have the best knowledge bases regarding the subject matter of the query. The user knowledge profile management system and the specific manner of identifying the N-best target users may be, for example, such as described in U.S. Pat. No. 6,253,202 of D. Gilmour, or any other kind of knowledge profile system which provides similar functionalities.

Then, at block 1603, for each target user selected, the target computer associated with the target user is identified. This task may be handled by the user filtering logic, or any other logic control within or outside the searchcasting server. The mapping between a user and a computer associated with the user may be stored in the user profile system or another database. Because it is well within the knowledge of a skilled in the relevant art, it is not necessary to discuss the detailed implementations of the mapping mechanism here.

After the target computers are selected at block 1603, the searchcasting server encapsulates the search in a query object and sends the query object to all of the selected target computers for content match (at block 1604). After sending the query object to all selected computers, the searchcasting server starts waiting for responses from these computers at block 1605. If a response to the search is received (at block 1606), the searchcasting server sends the responding computer a request (at block 1607). Upon receiving the request from the searchcasting server, the target computer alerts the user that searchcasting has matched information on his computer. Similar to other embodiments, a dialog box is display to the user to inform the user of the match, the querying user's identity, the information sought, the deadline to respond, and options to authorize or deny the release of the information. Alternatively, email may be used if the user is temporarily off the computer. If a response is not received at 1606, the searchcasting server checks, at block 1608, whether there is enough time left before the responding deadline. If so, the process loops back to 1605 to wait for new responses; otherwise, the process ends.

On the target computer side, the process is illustrated in FIG. 17. At block 1701, the target computer receives a query object. The search encapsulated in the query object is executed and matched with the information stored on the computer at block 1702. If the degree of match exceeds a predetermined threshold, then, at block 1703, the user will be alerted of a searchcasting match, and be given opportunity to either authorize or deny the release of information sought by the querying user (at block 1704), similarly as discussed earlier. Otherwise, the computer ignores the search at block 1605.

Note that after a target user authorizes the release of the information sought by a querying user, the information (i.e., a Word document, an answer to a question, etc.) may be sent directly to the email account of the querying user, or sent to the searchcasting server, from which the querying user may access them. Further, as mentioned in the beginning, a target user may choose to respond to a query by ways other than releasing matched information. For example, the user may choose to send a message asking the querying user to contact him. Especially, when content match is not a match measure for a query (i.e., the match is based on whether the target user is interested in the subject matter of the query), the target user has no matched information to release or not to release. In that situation, the user will choose to respond to the query in other ways if he still desires to. In addition, a user may have an option to forward the information to a repository, such that it would be available to a group in the future without having to have its owner participate in a repetitive searchcast. It might be possible to have such a repository participate in a searchcast group as if it were a user. In other words, this simulated user, which would actually be a server computer, would receive queries, process them, and immediately respond with the content, as if its user had approved doing so.

In addition, before a target user authorizes the release of the information sought, all communications from the target computer to the searchcasting server are anonymous such that they cannot be used to identify the identity of the target user. No private information leaves the target computer until the user of that computer (i.e., the “owner” of that information) allows it. Thus, the privacy issue is also addressed in this searchcasting system.

Thus, a method, system and apparatus for searchcasting have been described.

Software to implement the technique introduced here may be stored on a machine-readable medium. A “machine-accessible medium”, as the term is used herein, includes any mechanism that provides (i.e., stores and/or transmits) information in a form accessible by a machine (e.g., a computer, network device, personal digital assistant (PDA), manufacturing tool, any device with a set of one or more processors, etc.). For example, a machine-accessible medium includes recordable/non-recordable media (e.g., read-only memory (ROM); random access memory (RAM); magnetic disk storage media; optical storage media; flash memory devices; etc.), etc.

“Logic”, as is used herein, may include, for example, software, hardware and/or combinations of hardware and software.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A method comprising:
sending a user initiated query for information to a plurality of computers distributed on a network;
receiving a first message in response to the query from at least one of the computers; and
in response to said first message or messages, sending a second message to at least one of the computers, to cause the computer to prompt a user of the computer to indicate permission or denial of permission to send a response to the query.

2. The method of claim 1, wherein each first message comprises a bid from the corresponding computer, wherein the method further comprises, prior to said sending a second message to at least one of the computers:
determining at least one winning bid from the first message or messages; wherein said sending a second message to at least one of the computers comprises sending the second message only to a computer from which a first message having a winning bid is received.

3. The method of claim 2, wherein the bid represents a strength of correspondence between the query and a set of information stored on the corresponding computer.

4. The method of claim 2, wherein the bid represents a strength of a relationship between a user who initiated the query and a user of the corresponding computer.

5. The method of claim 2, wherein the bid represents a strength of knowledge base of a user of the corresponding computer with respect to a subject matter of the query.

6. The method of claim 1, wherein each first message results from a corresponding one of the computers detecting a match, wherein each match is a satisfaction of a condition by at least one measure related to the query.

7. The method of claim 6, wherein one of said at least one measure represents a strength of correspondence between the query and a set of information stored on the corresponding computer.

8. The method of claim 6, wherein one of said at least one measure represents a strength of a relationship between a user who initiated the query and a user of the corresponding computer.

9. The method of claim 6, wherein one of said at least one measure represents a strength of knowledge base of a user of the corresponding computer with respect to a subject matter of the query.

10. The method of claim 6, wherein the condition is scheduled to be adjusted periodically by said server.

11. The method of claim 6, wherein the condition is scheduled to be adjusted periodically at the corresponding computer.

12. The method of claim 1, wherein said send a response to the query comprises releasing a set of information stored on the computer.

13. The method of claim 1, wherein the method further comprises, prior to said sending the user initiated query for information to the plurality of computers distributed on the network:
accessing a plurality of user profiles, each user profile associated with a user of a separate one of the plurality of computers;
selecting a plurality of users, based on the profiles; and
selecting the plurality of computers based on the selected users, wherein each computer is associated with a separate one of the users.

14. The method of claim 13, wherein said selecting a plurality of users, based on the profiles, comprises selecting a user if, according to the user profile associated with the user, a strength of relationship between the user and a user who initiated the query exceeds a first threshold.

15. The method of claim 13, wherein said selecting a plurality of users, based on the profiles, comprises selecting a user if the user has a knowledge base with respect to a subject matter of the query, which, according to the user profile associated with the user, has a strength exceeds a second threshold.

16. A machine-readable medium having sequences of instructions stored therein which, when executed by a processor, cause the processor to perform a process comprising:
providing a user initiated query for information to a plurality of computers distributed on a network;
receiving a first message in response to the query from at least one of the computers, wherein each first message comprises a bid from the corresponding computer;
in response to said first message or messages, sending a second message to at least one of the computers to cause the computer to prompt a user of the computer to indicate permission or denial of permission to send a response to the query.

17. The machine-readable medium of claim 16, wherein the bid represents a strength of correspondence between a set of information stored on the corresponding computer and the query.

18. The machine-readable medium of claim 17, wherein the bid further represents a strength of relationship between a user who initiated the query and a user of the corresponding computer.

19. The machine-readable medium of claim 18, wherein the bid further represents a strength of knowledge base of the user of the corresponding computer with respect to a subject matter of the query.

20. A processing system comprising:
a processor; and
a memory coupled to the processor, the memory storing instructions which when executed by the processor, cause the processing system to perform a process comprising:
sending a user initiated query for information to a plurality of computers distributed on a network;
receiving a first message in response to the query from at least one of the computers, wherein each first message results from a corresponding one of the computers detecting a match, the match representing a satisfaction of a first condition by a strength of correspondence between the query and a set of information stored on the corresponding computer; and
in response to said first message or messages, sending a second message to at least one of the computers to cause the computer to request a user of the computer to authorize the release of the set of information stored on the computer.

21. The processing system of claim 20, wherein the match further represents a satisfaction of a second condition by a strength of relationship between a user who initiated the query and a user of the corresponding computer.

22. The processing system of claim 21, wherein the match further represents a satisfaction of a third condition by a strength of knowledge base of the user of the corresponding computer with respect to a subject matter of the query.

23. The processing system of claim 20, wherein the method further comprises, prior to sending the user initiated query for information to the plurality of computers distributed on the network:
accessing a plurality of user profiles, each profile associated with a separate user;
selecting at least one user, each selected user having a relationship with a user who initiated the query according to a user profile associated with the selected user, wherein a strength of the relationship exceeds a first threshold; and
selecting the plurality of computers, wherein each computer is associated with one of the users.

24. The processing system of claim 23, each selected user further having a knowledge base with respect to a subject matter of the query, wherein a strength of the knowledge base, according to the user profile associated with the user, exceeds a second threshold.

25. A method comprising:
receiving, at a computer from a server, a user initiated query for information, the query also being received from the server by at least one other computer;
sending, to said server, a first message in response to the query;
receiving at the computer, from the server, a second message in response to the first message, the second message to cause the computer to prompt a user of the computer to indicate permission or denial of permission to send a response to the query.

26. The method of claim 25, wherein the first message comprises a bid representing a strength of correspondence between the query and a set of information stored on the computer, the server then determining whether the bid is a winning bid after receiving said first message.

27. The method of claim 26, wherein the bid further represents a strength of relationship between the user of the computer and a user who initiated the query.

28. The method of claim 27, wherein the bid further represents a strength of knowledge base of the user of the computer with respect to a subject matter of the query.

29. The method of claim 28, wherein said receiving at the computer, from the server, a second message in response to the first message, the second message to cause the computer to prompt a user of the computer to indicate permission or denial of permission to send a response to the query occurs only if the bid is determined to be a winning bid.

30. A machine-readable medium having sequences of instructions stored therein which, when executed by a processor, cause the processor to perform a process comprising:
receiving, at a computer from a server, a user initiated query for information, the query also being received from the server by at least one other computer;
sending, to said server, a first message in response to the query, wherein the first message results from a satisfaction of a first condition by a strength of correspondence between a set of information stored on the computer and the query; and
receiving at the computer, from the server, a second message in response to the first message, the second message to cause the computer to prompt a user of the computer to indicate permission or denial of permission to release the set of information to a user who initiated the query.

31. The machine-readable medium of claim 30, wherein the first message results from a further satisfaction of a second condition by a strength of a relationship between a user who initiated the query and the user of the computer which sent the first message.

32. The machine-readable medium of claim 31, wherein the first message results from a further satisfaction of a third condition by a strength of a knowledge base of the user with respect to a subject matter of the query.

33. A method comprising:
receiving, at a first computer from a server, a user initiated query for information, the query also being received from the server by at least a second computer; and
upon detecting a match at the first computer, prompting a user of the computer to indicate permission or denial of permission to send a response to the query, wherein the match is a satisfaction of at least one condition correspondingly by at least one of a set of measures related to the query.

34. The method of claim 33, wherein the set of measures consists of one or more the following:
a measure representing a strength of correspondence between a set of information stored on the computer and the query;
a measure representing a strength of a relationship between the user of the computer and a user who initiated the query;
a measure representing a strength of a knowledge base of the user of the computer with respect to a subject matter of the query; and
a measure specified by the user of the computer.

35. The method of claim 33, wherein said prompting the user of the computer to indicate permission or denial of permission to send a response to the query takes place only after the server has permitted the computer to do so.

36. The method of claim 34, wherein said at least one condition is periodically adjusted at the server.

37. The method of claim 33, wherein said send a response to the query comprises release a set of information stored on the computer.

38. The method of claim 33, wherein said send a response to the query comprises send a message in response to the query.

39. A machine-readable medium having sequences of instructions stored therein which, when executed by a processor of a computer, cause the processor to perform a process comprising:
requesting and receiving, from a server, a user initiated query for information;
determining whether at least one condition is satisfied correspondingly by at least one of a set of measures related to the query, wherein said at least one condition is requested from the server; and
if said at least one condition is satisfied correspondingly by said at least one of a set of measures, notifying a user of the computer to indicate permission or denial of permission to send a response to the query.

40. The machine-readable medium of claim 39, wherein the set of measures consists of one or more of the following:
a measure representing a strength of correspondence between a set of information stored on the computer and the query;
a measure representing a strength of a relationship between the user of the computer and a user who initiated the query;
a measure representing a strength of a knowledge base of the user of the computer with respect to a subject matter of the query; and
a measure specified by the user of the computer.
